(19) United States
(12) Patent Application Publication
(10) Pub. No.: US 2026/0212788 A1
(43) Pub. Date: Jul. 23, 2026

(54) Means of Locomotion, Device and Method for Adjusting a Depth of Detail of an Augmented-Reality User Interface of a Means of Locomotion

(71) Applicant: BAYERISCHE MOTOREN WERKE AKTIENGESELLSCHAFT, München (DE)

(72) Inventor: Olivier PITRAT, Muenchen (DE)

(21) Appl. No.: 19/139,912

(22) PCT Filed: Nov. 9, 2023
(86) PCT No.: PCT/DE2023/100852

§ 371 Date: Jun. 17, 2025

(30) Foreign Application Priority Data
Dec. 20, 2022 (DE) 10 2022 134 238.7

(51) Int. Cl. G09G 3/00; G06F 3/01; G06F 3/042

(52) U.S. Cl. CPC G09G 3/001; G06F 3/013; G06F 3/0425; G09G 2354/00; G09G 2380/10

(57) ABSTRACT

A means of locomotion, a device and a method for adjusting a depth of detail of an augmented-reality user interface of a means of locomotion are provided. The method includes determining a predefined position of a finger of a user on a translucent surface in the interior of the means of locomotion, and in response thereto, adjusting the depth of detail of an augmented-reality display.

### BACKGROUND AND SUMMARY

The present invention relates to a means of locomotion, a device, and a method for adjusting a depth of detail of an augmented reality (AR) user interface of a means of locomotion. In particular, the present invention relates to a discreet interaction option for a user in the configuration of an AR mix in the means of locomotion.

Users typically operate their means of locomotion via hardware buttons/sliders and touchscreens or other touch-sensitive and/or pressure-sensitive user interfaces embodied in hardware. A particularly discreet option for interaction has become known in the meantime as “shy tech”. In this case, a translucent display of operating elements takes place on a surface, which can have, for example, a fabric and/or wood appearance or the like. The display of the user interface takes place via a rear-side projection (rear projection) while the determination of the position of the finger of a user on this user interface takes place by way of sensors (capacitive, electro-resistive, or the like) integrated in the materials.

In addition, AR user interfaces in means of locomotion are gaining ground. This is understood as the artificial augmentation of vehicle surroundings viewed directly by an occupant. For example, in this case contact-analogous notifications on surroundings objects are also output to the user after an eye position of the user and a position of a surroundings object have been determined. The AR contents are now displayed at the intersection of the optical axis between the above-mentioned points and the display surface. Up to this point, there were no setting options on the user side for a selection of the possibly configurable AR contents or AR functions. In other words, the user was always dependent on the contents of the AR user interface offered and displayed on the developer side appealing to him.

Proceeding from the above-mentioned prior art, it is an object of the present invention to be able to perform an AR-related configuration of a user interface acceptable to a user in a convenient manner.

The above-mentioned object is achieved according to the claimed invention by a method for adjusting a depth of detail of an augmented reality user interface of a means of locomotion.

The method can be carried out in a means of locomotion (passenger vehicle, van, motorcycle, truck, aircraft, and/or watercraft). The augmented reality user interface can make use of a display device of the means of locomotion and/or a display device worn by the user. In a first step, a predefined position of a finger of the user on a translucent surface in the interior of a means of locomotion is detected. In other words, the finger of the user is located when it approaches a translucent surface or touches it. This can take place, for example, by way of an infrared camera which continuously captures the translucent surface. The finger of the user can be determined in this case on the basis of its infrared signature. In response to the determination of the finger at the predefined position, the depth of detail of the augmented reality display is adjusted by the augmented reality user interface. This adjustment can take place automatically. In other words, the predefined position stands for a specific depth of detail, which can be predefined step-by-step and/or continuously. The depth of detail can relate to different contents/features of the augmented reality display. For example, specific categories of surroundings objects may not be highlighted by AR contents in a first stage, while in a second depth of detail, these categories of surroundings objects are optically highlighted for the user of the interface according to embodiments of the invention. However, a plurality of user interfaces/display devices/enlarged display surfaces or the like can also be used if the depth of detail is increased. Further examples of the depth of detail will be provided in the further course of the present disclosure.

Preferably, the determination of the position of the finger can take place by way of an optical sensor. The optical sensor can be arranged, for example, in a roof lining and/or in an A-pillar and/or in a roof operating module/“roof” function center. The optical sensor can comprise, for example, an infrared camera which can also be used, for example, for further functions in the means of locomotion (e.g., seat occupancy detection, fatigue detection, detection of vital dimensions, or the like). The hardware expenditure for the implementation of the device according to embodiments of the invention is therefore reduced.

A translucent surface can be arranged, for example, in a door panel and/or on a dashboard of the means of locomotion. It can have fibers and/or holes or the like, through which light projected on the rear side can emerge with comparatively sharp contours from the surface of the translucent surface. In this way, it is possible to display switch elements and/or visualize their operating status (activated/deactivated) or the like.

The translucent surface can preferably have a fabric and/or a wood trim and/or a fiber material. Holes and/or optical fiber elements can be introduced into the surface such that the optical appearance with designed rear projection corresponds to a natural, in particular organic or inorganic material. In other words, in particular a classic design of a matrix display is not recognizable when the display device is switched off. A dynamic appearance of the user interface according to embodiments of the invention is only activated by way of the translucent surface when the rear projection is switched on. This does not preclude predefined positions also being optically perceptible on the translucent surface without the rear projection. For example, the material can be structured differently and/or colored differently in order to also have predefined positions recognized without the rear projection. In particular, in response to the detection of a finger of the user in a predefined spatial relationship to the predefined position or another predefined position, the rear spatial projection can be activated and the user interface can therefore be enriched with further optical details. By switching on the rear spatial projection, for example, one predefined position or multiple (in particular adjacent) predefined positions, preferably all predefined positions of the user interface, can be marked and/or optically highlighted. For example, the predefined positions can also be optically merged in that a boundary line, a frame, or the like is arranged around the predefined positions, which are arranged in particular in the form of a circular structure or in the form of a line (linearly). The depth of detail of the AR display can have further accompanying parameters, which are not necessarily based on AR technology and which are output for example by way of vibration exciters and/or fans and/or heating/air conditioning systems and/or odorants and/or classic display devices. For example, in a first detail level, a vibration exciter can be used to envision specific events/surroundings objects, while the vibration exciter is not to be used in another (in particular lower) detail level. This applies accordingly for the use of a scent bottle and/or a fan stage and/or heating/air conditioning system temperature. If windowpanes capable of dynamic darkening are provided in the means of locomotion, the darkening of the windowpanes can be provided in a (higher) first detail level, while such darkening is not provided in a lower detail level. This applies accordingly for the number of projectors to be used, the category and position of surroundings objects which are referred to in the course of the AR display, and the actuators to be used and their parameters upon response to predefined events.

The detail levels which can be activated or changed by the above-described user interface can relate, for example, to the following contents: in a first level (level 0) all AR and accompanying signaling is switched off. In a second level (level 1), the classic head-up display having the known contents is used. A lane departure warning or the like is possibly signaled by way of seat vibration. In a third level (level 2), the head-up display is used by a three-dimensional component (depth head-up display), optionally also seat vibration pattern, smartwatch incorporation, and fan for breeze and scenting for the provision of the AR user experience. In the last level (level 4), the darkening of the windowpanes of the means of locomotion is additionally caused (for example, by way of electrochromic substances), in response to which a completely virtual surroundings image is projected on the now darkened windowpanes. In this case, if this is desired, surroundings objects and other surroundings features can in principle be freely represented by alternative display objects so that the user if necessary experiences an entertaining alienation from the surroundings. If the windowpanes are only made fractionally opaque in this status, this display corresponds to an AR environment. This can merge into a virtual reality (VR) with (nearly) complete opacity of the windowpanes.

Independently of the current AR/VR depth of detail which has been selected by the user, an automatic partial release of a display device used for this purpose can be advantageous ergonomically and with respect to driving safety technology in particular if a surroundings objects having predefined properties has been determined by sensor in the surroundings of the means of locomotion. For example, the surroundings object can be located by way of a camera, a lidar sensor, and/or an ultrasonic sensor in the collision-relevant surroundings of the means of locomotion. In response thereto, a partial reduction or removal of display contents of the AR/VR display can take place in particular at those positions which are located in a line of sight of the user to the surroundings objects. In other words, independently of the presently displayed display contents, that area is switched to completely or fractionally transparent which is to be switched to transparent for an at least fractionally, in particular completely, unobstructed view of the user of the surroundings object. A predefined frame can be displayed around the surroundings object in this case or also kept free with reduced contents or completely empty of content in order to be able to classify the situation of the surroundings object better in the actual vehicle surroundings. A trajectory of the line of sight on the display device can preferably also be predicted, so that a larger area having reduced or completely removed display contents is reserved from the view of the user in the optical movement direction. In this way, the user can in particular see those surroundings areas unobstructed and naturally, due to the relative trajectory between the ego means of locomotion and the surroundings object, at which the surroundings object will be located shortly. Alternatively or additionally, depending on a position of the surroundings object, predefined display areas (e.g., left half of the display, right half of the display, lower half of the display, upper half of the display, or the like) can also be switched to completely transparent or operated reduced by AR/VR contents. In this way, an area or a corona results around the surroundings object, within which the surroundings are also recognizable essentially or completely unobstructed for the user. Of course, for this purpose in an advantageous embodiment initially the position of the eyes of the user is to be established by sensor in order to establish the line of sight and be able to release it as described above. Such methods are known in principle in the prior art.

The predefined property of the surroundings object can in particular decide about the extent to which there is the probability that the user would rather receive an unobstructed view of the surroundings object instead of having to look through an AR/VR-subjected display. In particular, this can be directed to a collision relevance or its associated information. Such information includes, for example, the distance, the velocity, the relative movement direction, a predicted trajectory, a mass, a material of the surroundings object, or further information. An identification of the surroundings object (e.g., wirelessly, by data processing, electromagnetically, or the like) can also take place. In particular, the surroundings object can also be categorized for this purpose, wherein predefined properties are assigned to the category found, which as described above can be used to switch the transparency of the display device.

According to a second aspect of the present invention, a device for adjusting a depth of detail of an augmented reality user interface of a means of locomotion is proposed. The user interface could also be understood as a driver assistance system of the means of locomotion (e.g., a passenger vehicle, van, motorcycle, truck, aircraft, and/or watercraft). The device comprises a data input, an evaluation unit (for example, an electronic controller), and a data output. The evaluation unit is therefore configured to determine a predefined position of a finger of a user on a translucent surface in the interior of the means of locomotion by way of the data input and in response thereto to adjust the depth of detail of the augmented reality display if necessary by way of the data output. This step can take place automatically. In other words, the device according to embodiments of the invention is obviously configured to effectuate the features, combinations of features, and the advantages resulting therefrom in a corresponding manner, such that to avoid repetitions, reference is made to the above statements in conjunction with the method according to embodiments of the invention.

According to a third aspect of the present invention, a means of locomotion is proposed which has a device according to the second-mentioned aspect of the invention. The features, combinations of features, and advantages also result in a corresponding manner in this regard.

Further details, features, and advantages of the invention result from the following description and the figures.

### BRIEF DESCRIPTION OF THE DRAWINGS

FIG. 1 shows a perspective view of an interior of a means of locomotion according to embodiments of the invention having an exemplary embodiment of a device according to the invention during the performance of a method according to embodiments of the invention.

FIG. 2 shows a flow chart illustrating steps of an exemplary embodiment of a method according to the invention for adjusting a depth of detail of an augmented reality user interface of a means of locomotion.

### DETAILED DESCRIPTION OF THE DRAWINGS

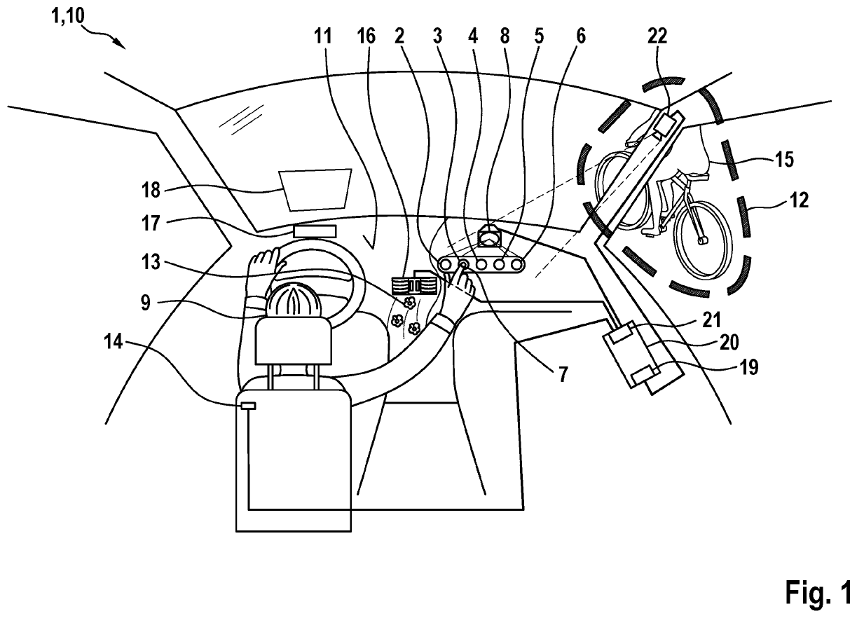

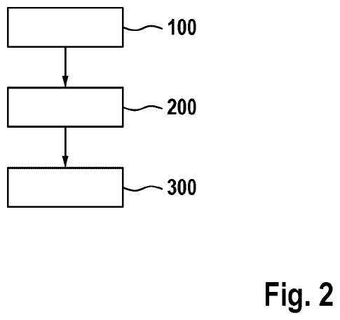

FIG. 1 shows a driver workspace of an exemplary embodiment of a means of locomotion 10 according to the invention in the form of a passenger vehicle. The user 9 has taken his seat on the driver seat and wishes to adjust the manner in which a bicyclist 15 located to the right of the means of locomotion 10 is optically highlighted. For this purpose, he strokes his finger 7 over a translucent surface 11 located in the dashboard at a predefined position 3. The predefined position 3 is discreetly permanently marked. This applies accordingly for predefined positions 2, 4, 5, and 6 adjacent to the predefined position 3. An infrared camera 22 in the area of an A-pillar captures the finger 7 at the predefined position 3 and reports these data via a data input 19 to an electronic controller as the evaluation unit 20. The evaluation unit 20 identifies the finger 7 of the user 9 and causes a projector 8 to provide a rear projection by way of a data output 21 in order to visualize a border around the predefined positions 2 to 6. By moving his finger 7, the user 9 can now select a degree of detail which is associated with one of the predefined positions 2 to 6 in order to adjust the augmented reality display 12 around the bicyclist 15 according to his preferences. In the course of this, operating parameters of a fan 16, which can introduce scents 13 into the interior, and a vibration exciter 14 are also adjusted via the data output 21. The higher the detail level of the AR display, the more the above-mentioned actuators and features of the means of locomotion 10 are used to provide an AR user experience. In the course of this, reference is also made to a projector 17 of a head-up display, the display surface 18 of which can be increased or reduced in size depending on the selected predefined position 2 to 6. The method discussed in conjunction with FIG. 2 can be performed by way of the device 1 shown.

FIG. 2 shows steps of an exemplary embodiment of a method according to the invention. In step 100, a predefined position of a finger of a user on a translucent surface in the interior of a means of locomotion is determined. The translucent surface can be, for example, a substance on a transparent carrier layer, behind which a projector is located. Matrix displays could also be used for this purpose, if they are sufficiently bright, to generate visible optical appearances for the user behind the translucent surface. In response to the fact that the finger of the user has been determined at the predefined position, in step 200, the depth of detail of the augmented reality display is adjusted. For this purpose, in one example, the category of surroundings objects which are highlighted by way of the augmented reality user interface by artificial optical notifications is changed. In step 300, a rear projection through the translucent surface is started as confirmation of the determined position of the finger of the user. In this way, the user receives feedback about the successful operation and the user interface is prepared in an optically appealing manner (since it is apparently presently being operated by the user).

### LIST OF REFERENCE SIGNS

1 device
2, 3, 4, 5, 6 predefined positions
7 finger
8 projector
9 user
10 means of locomotion
11 translucent surface
12 augmented reality display
13 odorant
14 vibration exciter
15 bicyclist
16 fan
17 projector
18 display surface
19 data input
20 evaluation unit
21 data output
22 infrared camera
100 to 300 method steps

1-13. (canceled)

14. A method for adjusting a depth of detail of an augmented reality user interface of a means of locomotion, the method comprising:
determining a predefined position of a finger of a user on a translucent surface in an interior of the means of locomotion, and
in response thereto, adjusting the depth of detail of an augmented reality display.

15. The method according to claim 14, wherein the determining of the predefined position of the finger takes place by way of an optical sensor.

16. The method according to claim 15, wherein the optical sensor is an infrared camera.

17. The method according to claim 14, wherein the translucent surface is arranged in at least one of a door panel or a dashboard of the means of locomotion.

18. The method according to claim 14, wherein the translucent surface comprises at least one of a fabric or a wood trim.

19. The method according to claim 14, wherein the predefined position is at least one of marked or optically highlighted by way of a rear spatial projection.

20. The method according to claim 14, wherein adjacent predefined positions are at least one of marked or optically highlighted by way of a rear spatial projection.

21. The method according to claim 14, further comprising:
starting a rear projection through the translucent surface in response to the determining of the predefined position of the finger.

22. The method according to claim 14, wherein the adjusting of the depth of detail of the augmented reality display comprises at least one of:
an increase or a decrease of surroundings objects which are highlighted or replaced in the augmented reality display,
an increase or a decrease of events which are acknowledged by way of at least one of a vibration exciter, a fan, or an aroma note,
an expansion or a reduction of a display surface of a head-up display,
a darkening of windowpanes of the means of locomotion, or
an increase or a reduction of projectors used to display the augmented reality.

23. The method according to claim 14, further comprising:
determining a surroundings object via sensors by way of the means of locomotion having a predefined property, and
in response thereto, reducing or removing display contents located in a line of sight of a user to the surroundings object.

24. The method according to claim 23, wherein the predefined property of the surroundings object defines at least one of:
a distance,
a size,
a mass,
a collision relevance, or
a trajectory.

25. The method according to claim 23, further comprising reducing or removing the display contents in a predefined area around the surroundings object, depending on a trajectory of the line of sight of the user in relation to the surroundings object.

26. A device for adjusting a depth of detail of an augmented reality user interface of a means of locomotion, the device comprising:
a data input,
an evaluation unit, and
a data output,
wherein the evaluation unit is configured:
to determine a predefined position of a finger of a user on a translucent surface in an interior of the means of locomotion by way of the data input, and
in response thereto, to adjust the depth of detail of an augmented reality display.

27. The means of locomotion comprising the device according to claim 26.
